(19) United States
(12) Patent Application Publication
(10) Pub. No.: US 2019/0331945 A1
(43) Pub. Date: Oct. 31, 2019

(54) LIGHT SOURCE MODULE AND DISPLAY DEVICE THEREOF

(71) Applicant: Coretronic Corporation

(72) Inventors: CHUNG-YANG FANG, Hsin-Chu (TW); PING-YEN CHEN, Hsin-Chu (TW); YANG-CHING LIN, Hsin-Chu (TW); JEN-WEI YU, Hsin-Chu (TW)

(21) Appl. No.: 16/388,883

(22) Filed: Apr. 19, 2019

(30) Foreign Application Priority Data
Apr. 26, 2018 (CN) 201810384717.9

(51) Int. Cl. G02F 1/13357; G02F 1/133; G02F 1/1343; G02F 1/1335

(52) U.S. Cl. CPC G02F 1/1336; G02F 1/13306; G02F 2001/133601; G02F 1/133528; G02F 1/1343

(57) ABSTRACT

A light source module includes an optical plate, a light source and a dimming liquid crystal panel. The dimming liquid crystal panel includes a first driving substrate, a second driving substrate and a liquid crystal material layer. The first driving substrate includes a first substrate, and a common electrode disposed between the first substrate and the liquid crystal material layer. The second driving substrate includes a second substrate, a plurality of independent electrodes, a plurality of first signal pads and a plurality of first wires. The independent electrodes, the first signal pads and the first wires are disposed between the second substrate and the liquid crystal material layer. The independent electrodes are insulated each other. Each of the independent electrodes is electrically connected to one of the first signal pads by one of the first wires. A display device having the light source module is also provided.

### CROSS-REFERENCE TO RELATED APPLICATION

THIS APPLICATION CLAIMS THE PRIORITY BENEFIT OF CHINA APPLICATION (CN201810384717.9 FILED ON APR. 26, 2018). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a light source module and its application, and more particularly to a light source module that can achieve local dimming and reduce the thickness of a backlight module, and a display device using the light source module.

### BACKGROUND OF THE INVENTION

The liquid crystal display device controls the brightness of image by illuminating the liquid crystal display panel with the backlight module. In order to enhance the contrast of the liquid crystal display device, the most commonly method is to use a backlight module having a local dimming function. The local dimming technology adjusts the brightness of light emitting diodes (LEDs) in different areas by mainly using a direct-type backlight module to achieve the function of local dimming.

In general, the local dimming technology of direct-type backlight module needs to balance between the thickness of the backlight module and the number of LEDs. The larger the number of LEDs, the shorter the light mixing distance, and the thinner the thickness of the backlight module; but the larger the number of LEDs, the higher the cost of the backlight module.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a light source module that uses the configuration of a dimming liquid crystal panel to achieve local dimming.

The invention provides a display device that enhances the contrast of a display screen by the local dimming of the light source module.

Other objectives and advantages of the invention can be further understood from the technical features disclosed by the invention.

In order to achieve one or partial or all of the above objectives or other objectives, a light source module provided by an embodiment of the invention includes an optical plate, a light source and a dimming liquid crystal panel. The optical plate has a light incident surface and a light exit surface. The light source is disposed beside the light incident surface. The dimming liquid crystal panel and the light exit surface of the optical plate are disposed opposite to each other. The dimming liquid crystal panel includes a first driving substrate, a second driving substrate and a liquid crystal material layer. The liquid crystal material layer is disposed between the first driving substrate and the second driving substrate. The first driving substrate includes a first substrate and a common electrode. The common electrode is disposed between the first substrate and the liquid crystal material layer. The second driving substrate includes a second substrate, a plurality of independent electrodes, a plurality of first signal pads and a plurality of first wires. The independent electrodes, the first signal pads and the first wires are disposed between the second substrate and the liquid crystal material layer. The independent electrodes are insulated each other. The first signal pads are disposed on at least one side of the second substrate. Each of the independent electrodes is electrically connected to one of the first signal pads via one of the first wires.

In order to achieve one or partial or all of the above objectives or other objectives, a display device provided by an embodiment of the invention includes a display panel and the above-mentioned light source module. The light source module includes an optical plate, a light source and a dimming liquid crystal panel. The display panel is disposed on a side of the dimming liquid crystal panel away from the optical plate.

The light source module of the embodiment of the invention disposes the dimming liquid crystal panel on the light exit surface of the optical plate. The dimming liquid crystal panel has a plurality of partition areas due to the arrangement and disposition of the independent electrodes. Each of the independent electrodes is connected to the first signal pad through the first wire, and each of the independent electrodes receives a driving signal via the single first wire and the single first signal pad. According to the driving signal, the light transmittance of each of the partition areas can be controlled independently, thereby achieving local dimming. In the display device of the embodiment of the invention, by selecting the light transmittance in different areas of the light source module, the contrast of the display screen of the display panel can be enhanced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a light source module according to an embodiment of the invention;

FIG. 2 is a schematic cross-sectional structural view of an optical plate and a dimming liquid crystal panel of a light source module according to an embodiment of the invention;

FIGS. 3A and 3B are respectively schematic structural views of a first driving substrate and a second driving substrate according to an embodiment of the invention;

FIG. 3C is a schematic structural view of a first driving substrate according to another embodiment of the invention;

FIG. 4 is a schematic perspective top view of a light source module according to an embodiment of the invention;

FIG. 5 is a schematic cross-sectional structural view of an optical plate and a dimming liquid crystal panel of a light source module according to another embodiment of the invention;

FIG. 6 is a schematic cross-sectional structural view of an optical plate and a dimming liquid crystal panel of a light source module according to another embodiment of the invention;

FIG. 7 is a schematic structural view of a plurality of independent electrodes according to another embodiment of the invention;

FIG. 8 is a schematic cross-sectional structural view of a display device according to a first embodiment of the invention;

FIG. 9 is a schematic cross-sectional structural view of a display device according to a second embodiment of the invention;

FIG. 10 is a schematic cross-sectional structural view of a display device according to a third embodiment of the invention; and

FIG. 11 is a schematic cross-sectional structural view of a display device according to a fourth embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

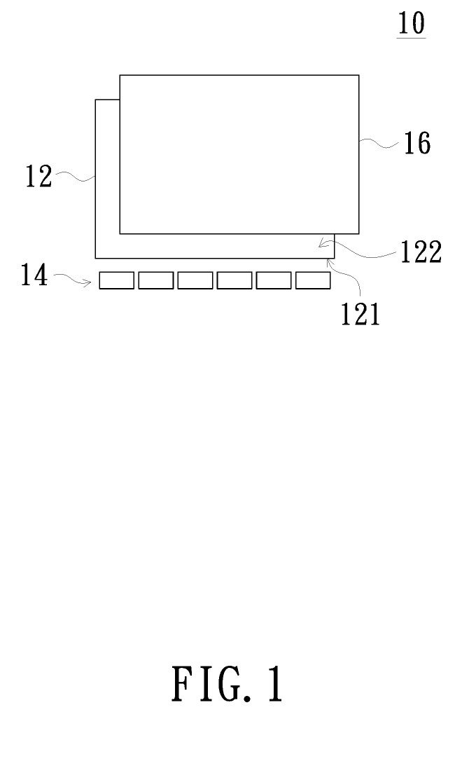

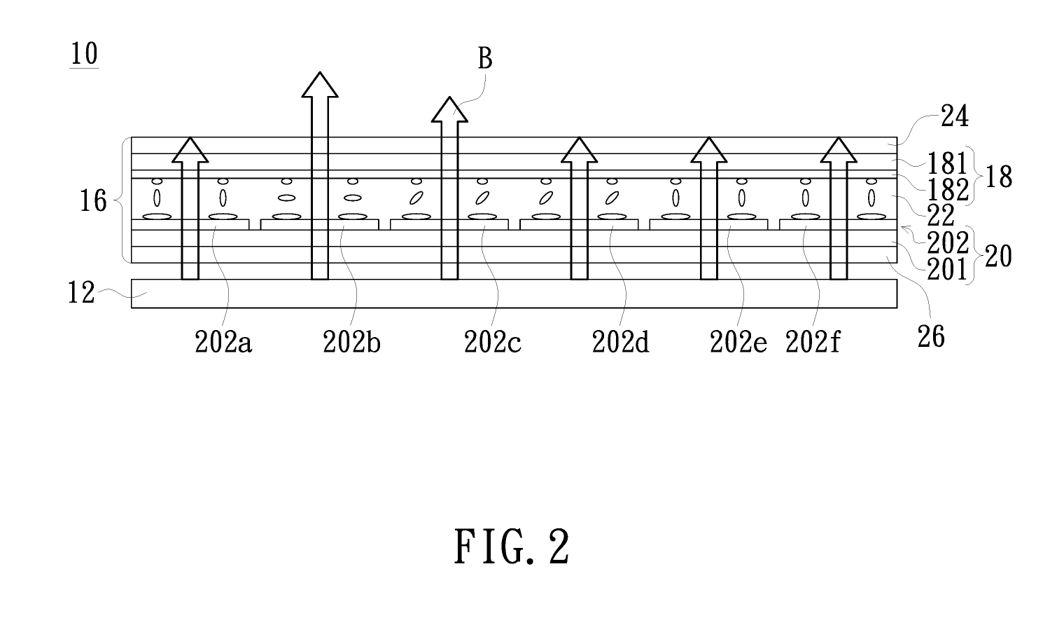

FIG. 1 is a schematic structural view of a light source module according to an embodiment of the invention. As shown in the figure, a light source module 10 includes an optical plate 12, a light source 14 and a dimming liquid crystal panel 16. The optical plate 12 of the embodiment is, for example, a light guide plate having a light incident surface 121 and a light exit surface 122. The light source 14 is disposed beside the light incident surface 121. The dimming liquid crystal panel 16 is disposed on the light exit surface 122 of the optical plate 12 and is disposed opposite to the light exit surface 122 of the optical plate 12. The invention does not limit the type of the optical plate 12 and its relative position to the light source 14. In other embodiments, the light source 14 can also be disposed below the optical plate 12. FIG. 2 is a schematic cross-sectional structural view of an optical plate and a dimming liquid crystal panel of a light source module according to an embodiment of the invention. Please also refer to FIG. 2, the dimming liquid crystal panel 16 includes a first driving substrate 18, a second driving substrate 20 and a liquid crystal material layer 22. The liquid crystal material layer 22 is disposed between the first driving substrate 18 and the second driving substrate 20. The liquid crystal alignment mode of the liquid crystal material layer 22 can comprises twisted nematic (TN), super twisted nematic (STN), vertical alignment (VA) or in-plane switching (IPS).

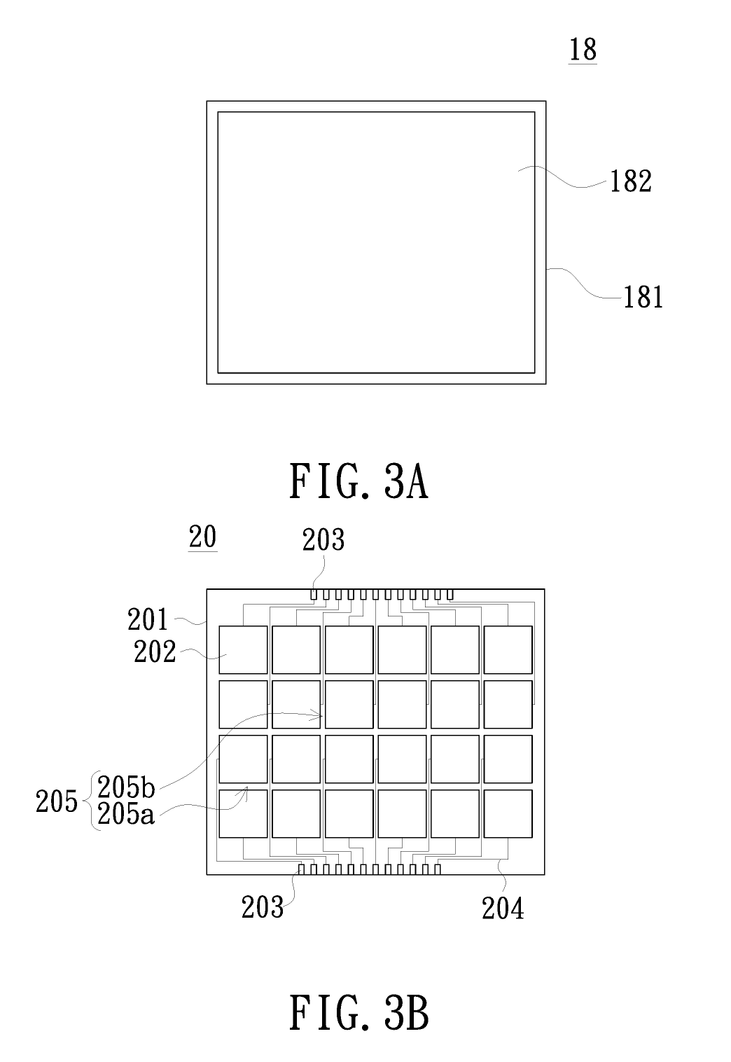

FIGS. 3A and 3B are respectively schematic structural views of a first driving substrate and a second driving substrate according to an embodiment of the invention. Please refer to FIGS. 2 and 3A, the first driving substrate 18 includes a first substrate 181 and a common electrode 182. The common electrode 182 is disposed between the first substrate 181 and the liquid crystal material layer 22. In an embodiment, the common electrode 182 is disposed on an inner surface (not numbered) of the first substrate 181 facing the liquid crystal material layer 22. Please refer to FIGS. 2 and 3B, the second driving substrate 20 includes a second substrate 201, a plurality of independent electrodes 202, a plurality of first signal pads 203 and a plurality of first wires 204. The independent electrodes 202, the first signal pads 203 and the first wires 204 are disposed between the second substrate 201 and the liquid crystal material layer 22, wherein the independent electrodes 202 are insulated each other, and the first signal pads 203 are located outside the range of the liquid crystal material layer 22. In the embodiment, the first signal pads 203 are disposed on at least one side of the second substrate 201, and each of the independent electrodes 202 is electrically connected to one of the first signal pads 203 (single signal pad) by one of the first wires 204 (single wire), wherein the first wires 204 are insulated each other. In an embodiment, the independent electrodes 202, the first signal pads 203 and the first wires 204 are disposed on an inner surface (not numbered) of the second substrate 201 facing the liquid crystal material layer 22.

Following the above description, as shown in FIG. 2, the dimming liquid crystal panel 16 of the light source module 10 further includes, for example, a first polarizer 24 and a second polarizer 26. The first driving substrate 18, the liquid crystal material layer 22 and the second driving substrate 20 are disposed between the first polarizer 24 and the second polarizer 26, wherein the first substrate 181 is located between the first polarizer 24 and the liquid crystal material layer 22, and the second substrate 201 is located between the second polarizer 26 and the liquid crystal material layer 22. In an embodiment, the first polarizer 24 includes at least one of a first absorption-type polarizing layer and a first reflection-type polarizing layer, and the second polarizer 26 includes at least one of a second absorption-type polarizing layer and a second reflection-type polarizing layer. Specifically, the first polarizer 24 and the second polarizer 26 can be an absorption-type polarizing layer, a reflection-type polarizing layer, or a stack of both, wherein the reflection-type polarizing layer is, for example, an advanced polarization conversion film (APCF) or a dual brightness enhancement film (DBEF).

The independent electrodes 202 are arranged in a matrix for example, and there are channels 205 between two adjacent rows of the independent electrodes 202 and between two adjacent columns of the independent electrodes 202. The channels 205 are, for example, a plurality of transverse channels 205a and a plurality of longitudinal channels 205b orthogonally arranged in a checkerboard pattern, as shown in FIG. 3B. In an embodiment, the longitudinal channel 205b is also formed between the independent electrode 202 adjacent to an edge (for example, the short side) of the second substrate 201 and the edge (for example, the short side) of the second substrate 201. The first signal pads 203 are, for example, disposed on opposite sides of an inner surface of the second substrate 201. By taking that the first signal pads 203 are disposed on two long sides of the second substrate 201 as an example, each of the first wires 204 is connected to each of the independent electrodes 202 from the first signal pads 203 along the longitudinal channels 205b parallel to the short sides of the second substrate 201, wherein each line (the first signal pad 203—the first wire 204—the independent electrode 202) is an independent connection, that is, the two adjacent lines are insulated. Since the first signal pads 203 are disposed on the opposite long sides of the second substrate 201, compared to the design of concentrating the first signal pads 203 on one side of the second substrate 201, the number of the first wires 204 on one side can be reduced by half, so that the number of the first wires 204 passing between each of the longitudinal channels 205b can be reduced, which can help to reduce the width of the longitudinal channels 205b, and also make the first wires 204 less noticeable. In the embodiment, each of the longitudinal channels 205b only needs one first wire 204 to pass therethrough at most.

In the embodiment, the materials of the independent electrodes 202, the first wires 204 and the first signal pads 203 are, for example, all transparent conductive materials, so that the manufacture of the independent electrodes 202, the first wires 204 and the first signal pads 203 can be completed in the same manufacturing process. In another embodiment, the material of the independent electrodes 202 is a transparent conductive material, and the materials of the first signal pads 203 and the first wires 204 are metal materials.

In addition to a full-chip design, the common electrode 182 of the first driving substrate 18 can also includes a plurality of independent sub-electrodes. FIG. 3C is a schematic structural view of a first driving substrate according to another embodiment of the invention. As shown in FIG. 3C, the first driving substrate 18A includes a first substrate 181, a plurality of independent sub-electrodes 185, a plurality of second signal pads 183, and a plurality of second wires 184. The independent sub-electrodes 185, the second signal pads 183 and the second wires 184 are disposed between the first substrate 181 and the liquid crystal material layer 22 (shown in FIG. 2). In an embodiment, the independent sub-electrodes 185, the second signal pads 183 and the second wires 184 are disposed on the inner surface (not numbered) of the first substrate 181 facing the liquid crystal material layer 22. The independent sub-electrodes 185 are insulated each other, and the independent sub-electrodes 185 respectively correspond to the independent electrodes 202 of the second driving substrate 20. The second signal pads 183 are disposed on at least one side of the first substrate 181 and located outside the range of the liquid crystal material layer 22. In an embodiment, the first signal pads 203 are disposed on the opposite long sides of the second substrate 201, and the second signal pads 183 are, for example, disposed on opposite short sides of the first substrate 181. Each of the independent sub-electrodes 185 is electrically connected to one of the second signal pads 183 (single signal pad) by one of the second wires 184 (single wire), wherein the second wires 184 are insulated each other. In the embodiment, the dimming liquid crystal panel 16 controls the light transmittance brightness of the area corresponding to the independent electrode (or the independent sub-electrode) on the dimming liquid crystal panel 16 by simultaneously controlling the voltages of the corresponding independent electrode 202 and the independent sub-electrodes 185.

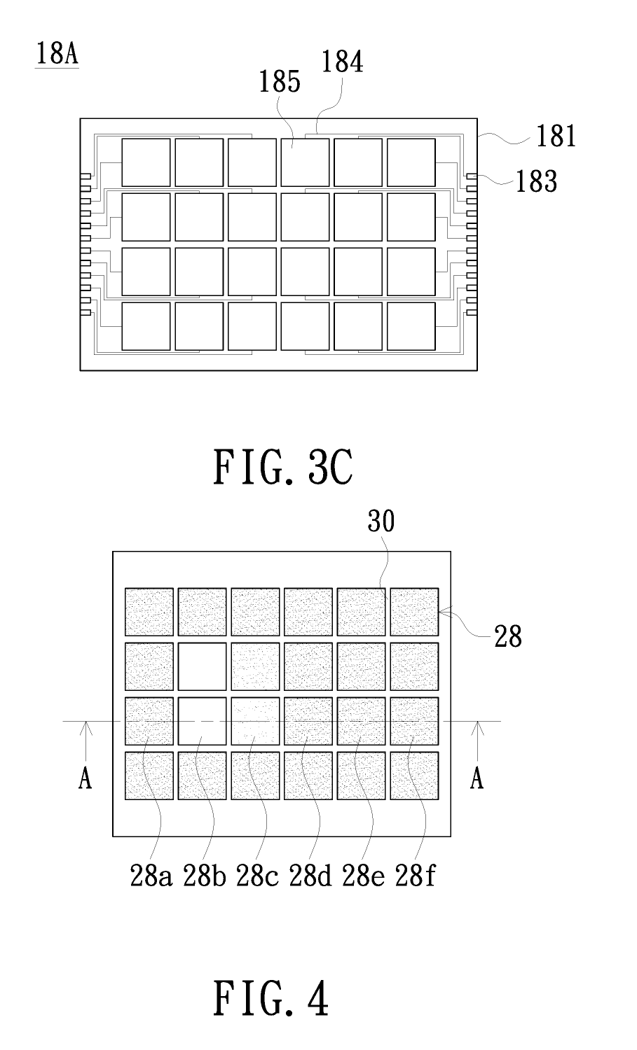

Please refer to FIG. 4, which is a perspective top view of a light source module according to an embodiment of the invention. The above-mentioned FIG. 2 is a cross-sectional view taken along line A-A of FIG. 4. As shown in FIG. 4, corresponding to the matrix arrangement of the independent electrodes 202, the dimming liquid crystal panel 16 has matrix-arranged partition areas 28. Please refer to FIGS. 2 and 4, each of the partition areas 28 corresponds to one independent electrode 202. The first signal pad 203 receives a driving signal. The driving signal is transmitted to the independent electrode 202 via the first wire 204. The independent electrode 202 controls the alignment direction of the liquid crystal molecules of the liquid crystal material layer 22 according to the magnitude of the voltage applied by the driving signal. In this way, each of the partition areas 28 can control the penetration rate of light (light transmittance) via the driving signal respectively. Taking FIG. 2 as an example, the common electrode 182 is applied with a voltage V1; the independent electrode 202a, the independent electrode 202d, the independent electrode 202e and the independent electrode 202f are applied with a voltage V2; the independent electrode 202b is applied with the voltage V1; the independent electrode 202c is applied with a voltage V3; and the voltage V1, the voltage V2 and the voltage V3 are different. In FIG. 2, the state of light transmittance of the partition areas 28 corresponding to the independent electrodes 202 to which different voltages are applied is indicated by an arrow B. Please refer to FIG. 4 at the same time, the partition areas 28 indicate the lightness of brightness by the degree of density of the dots, the most sparse or no dots indicates the brightest (i.e., the highest light transmittance), and the densest dots indicate the darkest (i.e., the lowest light transmittance). In an embodiment, in the partition areas 28 arranged along the A-A segment, the light transmittance of the partition area 28b corresponding to the independent electrode 202b is the highest, the light transmittance of the partition area 28c corresponding to the independent electrode 202c is the second highest, and the partition areas 28a, 28d, 28e and 28f corresponding to the independent electrodes 202a, 202d, 202e and 202f are opaque, for example, black display.

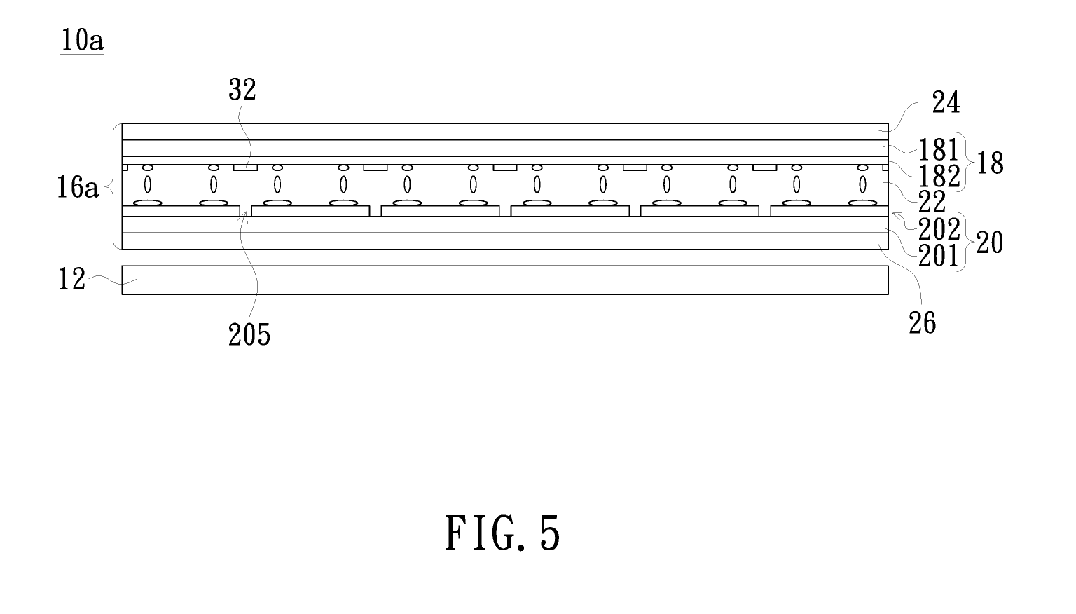

In an embodiment, since the channels 205 are disposed between the independent electrodes 202 of the dimming liquid crystal panel 16, the liquid crystal molecules of the liquid crystal material layer 22 at the channels 205 cannot be controlled. When the dimming liquid crystal panel 16 is in a normal white mode, if each of the partition areas 28 is controlled to have a low light transmittance, for example, black display, then a gap 30 between two partition areas 28 will transmit light. The position of the gap 30 corresponds to the channel 205 between the independent electrodes 202, thus, the light transmittance of the gap 30 causes bright grid lines to appear on the screen of the dimming liquid crystal panel 16. In order to shield light leakage, FIG. 5 is a schematic cross-sectional structural view of an optical plate and a dimming liquid crystal panel of a light source module according to another embodiment of the invention. The difference between the light source module shown in FIG. 5 and FIG. 2 lies in the light source module 10a illustrated in FIG. 5. The dimming liquid crystal panel 16a further includes a light shielding pattern layer 32. The light shielding pattern layer 32 is disposed on the common electrode 182 of the first driving substrate 18 and faces the second driving substrate 20. The light shielding pattern layer 32 corresponds to between the two adjacent independent electrodes 202. For example, the light shielding pattern layer 32 corresponds to the channel 205 between the independent electrodes 202, or slightly exceeds the width of the channel 205. In an embodiment, if the channels 205 are in a checkerboard pattern, the light shielding pattern layer 32 is also in a checkerboard pattern. Therefore, the light leakage phenomenon can be effectively reduced by setting the light shielding pattern layer 32.

In the above embodiment, the light shielding pattern layer 32 is disposed on the common electrode 182, but is not limited thereto. In the unillustrated drawings, the light shielding pattern layer 32 may also be disposed between the two adjacent independent electrodes 202 of the second driving substrate 20. In addition, if the dimming liquid crystal panel 16 is in a normal black mode, then the liquid crystal molecules of the liquid crystal material layer 22 at the channels 205 between the independent electrodes 202 are not controlled by the electric field. If each of the partition areas 28 is controlled to be low light transmittance, the gap 30 between two partition areas 28 will be in an opaque state. Therefore, the dimming liquid crystal panel 16 does not need to be disposed with the light shielding pattern layer 32.

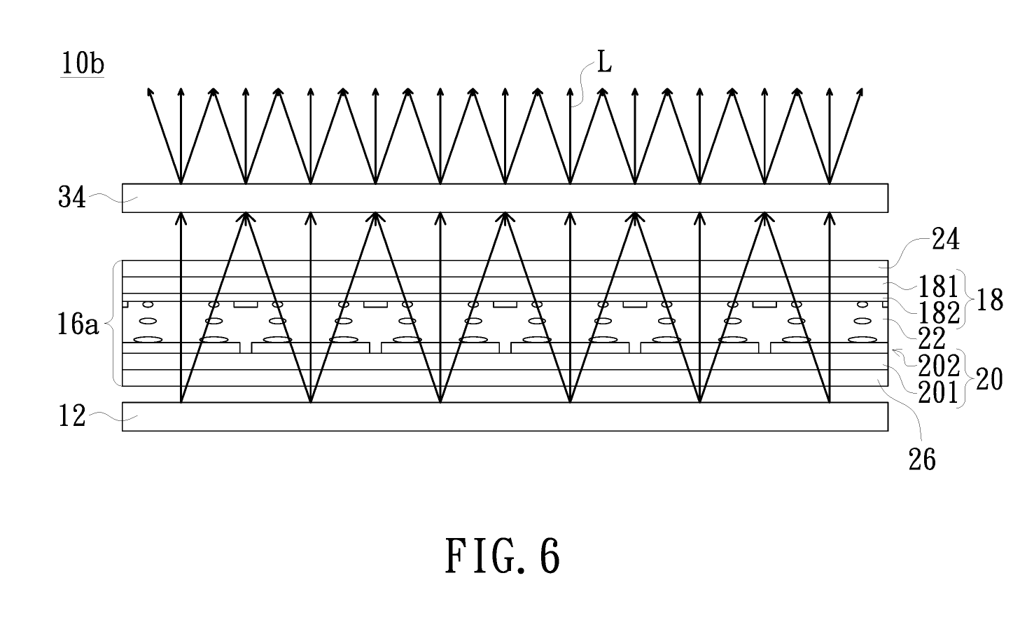

An embodiment in which the dimming liquid crystal panel 16a is disposed with the light shielding pattern layer 32 will be described below. When each of the partition areas 28 is controlled to have a high light transmittance, the setting of the light shielding pattern layer 32 will cause the gaps 30 between the partition areas 28 to be opaque and black grid lines will appear. In order to improve the problem, FIG. 6 is a schematic cross-sectional structural view of an optical plate and a dimming liquid crystal panel of a light source module according to another embodiment of the invention. The difference between the light source module shown in FIG. 6 and FIG. 5 lies in that the light source module 10b illustrated in FIG. 6 further includes a diffusion plate 34. The diffusion plate 34 is disposed at the side of the dimming liquid crystal panel 16a away from the optical plate 12. As shown in FIG. 6, the diffusion plate 34 can scatter the light L above the black grid lines area of the dimming liquid crystal panel 16a to obscure the black grid lines. In an embodiment, the diffusion plate 34 is preferably selected to have a low complex refractive index. For example, the material of the diffusion plate 34 comprises polycarbonate (PC), cyclic olefin polymer (COP), cyclic olefin copolymer (COC) or polymethyl methacrylate (PMMA). In an embodiment, the surface of the diffusion plate 34 has an embossed pattern.

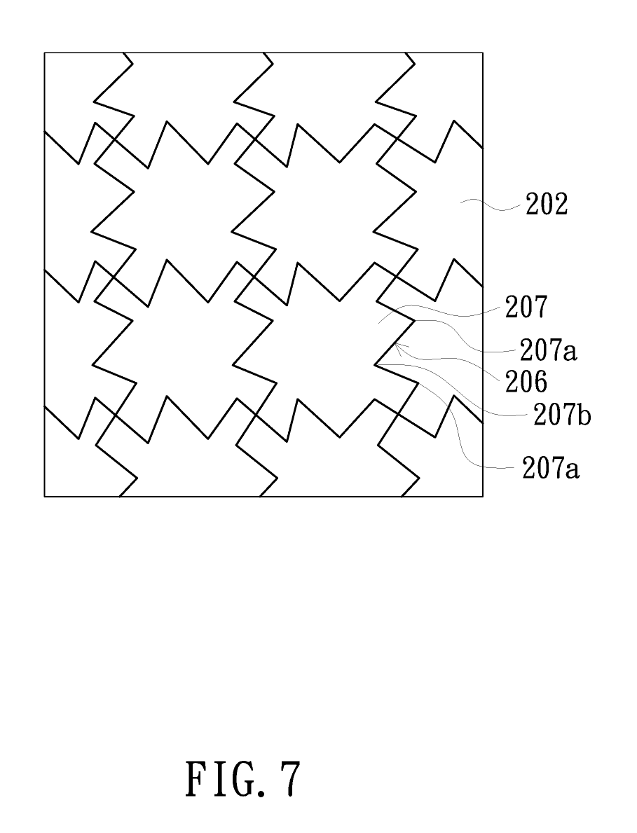

On the other hand, although the diffusion plate 34 can obscure the black grid lines between the partition areas 28, it may be necessary to use a diffusion plate 34 with high haze. The use of such high-haze diffusion plate 34 tends to reduce the luminance of the light source module 10b. Therefore, another way to obscure the black grid lines is by changing the edge structure of the independent electrodes 202. FIG. 7 is a schematic structural view of a plurality of independent electrodes according to another embodiment of the invention. As shown in the figure, the edge of each of the independent electrodes 202 is an indented structure 206, wherein the indented structure 206 includes a plurality of connected indented portions 207. In an embodiment, the height between a tooth peak 207a and a tooth valley 207b of each of the indented portions 207 is less than 100 microns, and the distance between the two adjacent tooth peaks 207a is less than 100 microns. Compared to regular lines, irregular lines are not easily identified, and therefore, changing the edges of the independent electrodes 202 to the indented structure 206 will further obscure the black grid lines. Due to the indented structure 206 of the edges of the independent electrodes 202, the luminance of the gap 30 of the two partition areas 28 (shown in FIG. 4) of the dimming liquid crystal panel 16 changes gradually, and thus the displayed image is more natural.

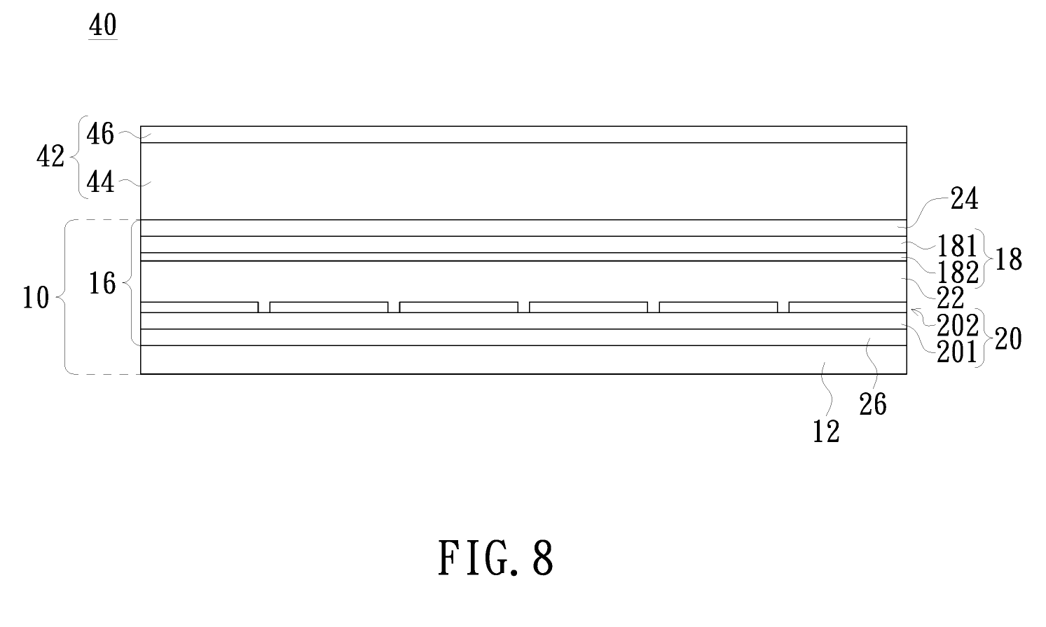

FIG. 8 is a schematic cross-sectional structural view of a display device according to a first embodiment of the invention. As shown in the figure, the display device 40 includes a display panel 42 and the light source module 10 described above. The display panel 42 is disposed on the side of the dimming liquid crystal panel 16 away from the optical plate 12. In order to facilitate the description below, it is defined that the dimming liquid crystal panel 16 is disposed above the optical plate 12, and the display panel 42 is disposed above the dimming liquid crystal panel 16. In an embodiment, the first driving substrate 18 is disposed on the side of the liquid crystal material layer 22 away from the optical plate 12, and the second driving substrate 20 is disposed on the side of the liquid crystal material layer 22 adjacent to the optical plate 12. Therefore, the disposition of the dimming liquid crystal panel 16 sequentially from top to bottom is the first polarizer 24, the first driving substrate 18, the liquid crystal material layer 22, the second driving substrate 20 and the second polarizer 26. The first polarizer 24 is located between the display panel 42 and the first driving substrate 18, and the second polarizer 26 is located between the optical plate 12 and the second driving substrate 20. In an embodiment, the display panel 42 shares the first polarizer 24 of the dimming liquid crystal panel 16. The display panel 42 includes a panel module 44 and a third polarizer 46, and the third polarizer 46 is disposed on the side of the panel module 44 away from the dimming liquid crystal panel 16. As shown in FIG. 8, the third polarizer 46 is disposed above the panel module 44.

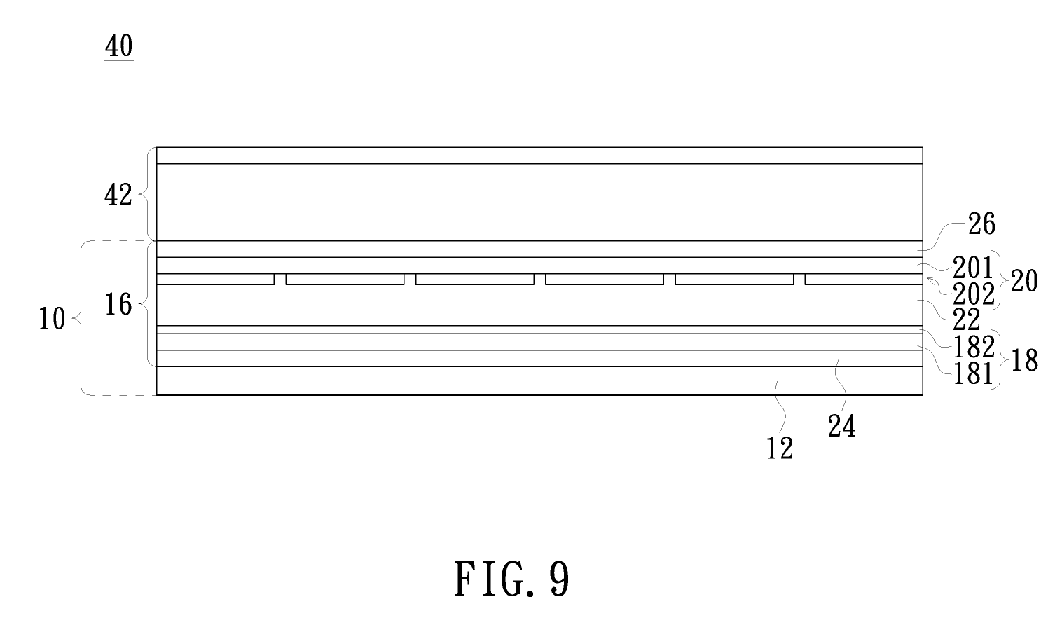

In the above first embodiment, the first driving substrate 18 is disposed on the side of the liquid crystal material layer 22 away from the optical plate 12, and the second driving substrate 20 is disposed on the side of the liquid crystal material layer 22 adjacent to the optical plate 12, that is, the first driving substrate 18 having the common electrode 182 is disposed above the liquid crystal material layer 22, and the second driving substrate 20 having the independent electrode 202 is disposed below the liquid crystal material layer 22, but are not limited thereto. FIG. 9 is a schematic cross-sectional structural view of a display device according to a second embodiment of the invention. As shown in FIG. 9, the second driving substrate 20 is disposed on the side of the liquid crystal material layer 22 away from the optical plate 12, and the first driving substrate 18 is disposed on the side of the liquid crystal material layer 22 adjacent to the optical plate 12, that is, the second driving substrate 20 having the independent electrode 202 is disposed above the liquid crystal material layer 22, the second polarizer 26 is located between the display panel 42 and the second driving substrate 20, the first driving substrate 18 having the common electrode 182 is disposed below the liquid crystal material layer 22, and the first polarizer 24 is located between the first driving substrate 18 and the optical plate 12.

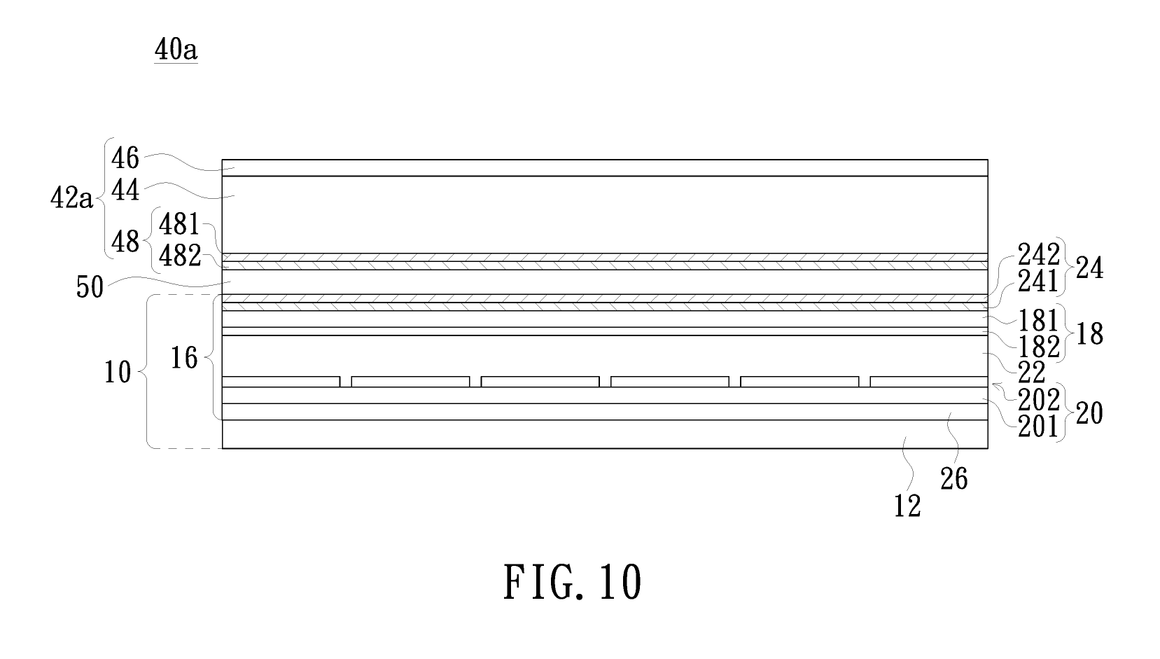

FIG. 10 is a schematic cross-sectional structural view of a display device according to a third embodiment of the invention. As shown in the figure, the display device 40a includes a display panel 42a and the light source module 10 described above. The display panel 42a is disposed on the side of the dimming liquid crystal panel 16 away from the optical plate 12. Different from the display device 40 of the first embodiment and the second embodiment, in the display device 40a of the third embodiment, the display panel 42a includes the panel module 44, the third polarizer 46 and a fourth polarizer 48. The third polarizer 46 is disposed on the side of the panel module 44 away from the dimming liquid crystal panel 16, for example, the third polarizer 46 is disposed above the panel module 44. The fourth polarizer 48 is disposed on the side of the panel module 44 facing the dimming liquid crystal panel 16, for example, the fourth polarizer 48 is disposed below the panel module 44. In an embodiment, if the dimming liquid crystal panel 16 is configured such that the first driving substrate 18 is disposed above the liquid crystal material layer 22 and the second driving substrate 20 is disposed below the liquid crystal material layer 22, then the fourth polarizer 48 of the display panel 42 is opposite to the first polarizer 24.

Following the above description, the display device 40a further includes a diffusion plate 50 disposed between the dimming liquid crystal panel 16 and the display panel 42a. In the third embodiment as shown in FIG. 10, the diffusion plate 50 is disposed between the first polarizer 24 and the fourth polarizer 48. The first polarizer 24 includes a first absorption-type polarizing layer 241 and a first reflection-type polarizing layer 242, and the fourth polarizer 48 includes a fourth absorption-type polarizing layer 481 and a fourth reflection-type polarizing layer 482. In an embodiment, the fourth reflection-type polarizing layer 482 and the first reflection-type polarizing layer 242 are located between the fourth absorption-type polarizing layer 481 and the first absorption-type polarizing layer 241, that is, the fourth reflection-type polarizing layer 482 and the first reflection-type polarizing layer 242 face each other, and the diffusion plate 50 is disposed between the fourth reflection-type polarizing layer 482 and the first reflection-type polarizing layer 242. The diffusion plate 50 is a low-haze diffusion plate, and the edges of the partition areas 28 of the dimming liquid crystal panel 16 (shown in FIG. 4) are obscured by having the light reflected back and forth between the fourth reflection-type polarizing layer 482 and the first reflection-type polarizing layer 242. The first reflection-type polarizing layer 242 and the fourth reflection-type polarizing layer 482 are, for example, an advanced polarization conversion film (APCF) or a dual brightness enhancement film (DBEF).

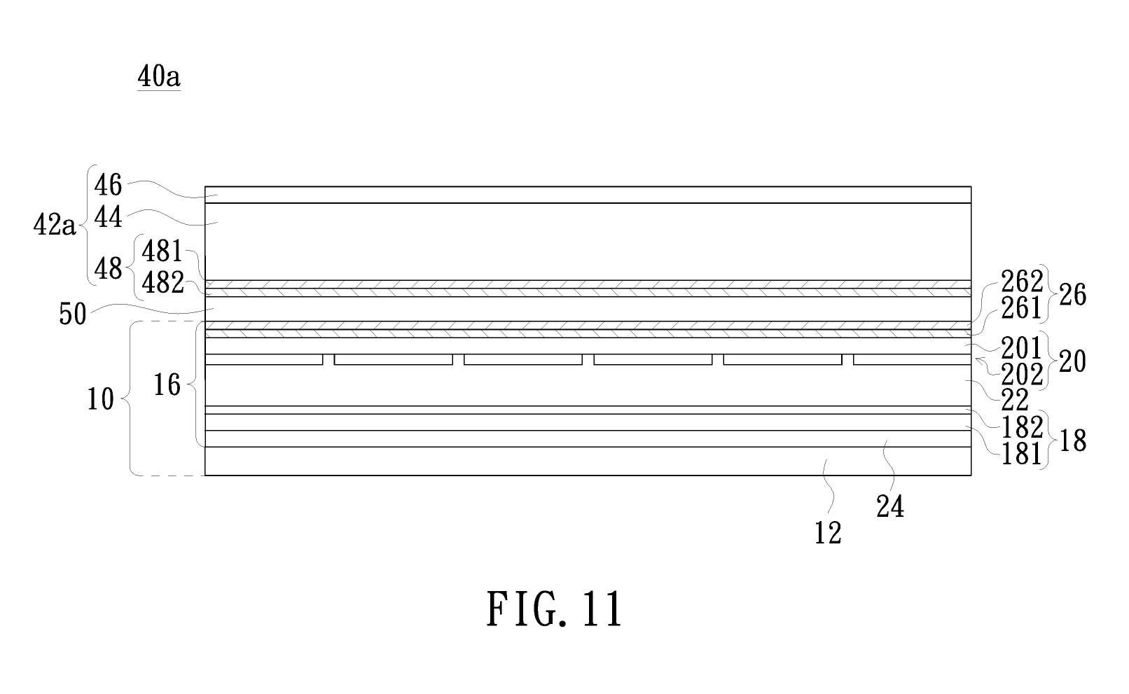

FIG. 11 is a schematic cross-sectional structural view of a display device according to a fourth embodiment of the invention. As shown in the figure, the difference from the third embodiment described above lies in that in the dimming liquid crystal panel 16, the second driving substrate 20 is disposed above the liquid crystal material layer 22 and the first driving substrate 18 is disposed below the liquid crystal material layer 22, the fourth polarizer 48 of the display panel 42a is disposed opposite to the second polarizer 26, and the diffusion plate 50 is disposed between the second polarizer 26 and the fourth polarizer 48. The second polarizer 26 includes a second absorption-type polarizing layer 261 and a second reflection-type polarizing layer 262. The fourth polarizer 48 includes a fourth absorption-type polarizing layer 481 and a fourth reflection-type polarizing layer 482. The diffusion plate 50 is disposed between the fourth reflection-type polarizing layer 482 and the second reflection-type polarizing layer 262.

In summary, the invention can achieve the following effects:

1. When the light source module of the embodiment is used as a backlight module, the light from the light source and directed to the dimming liquid crystal panel via the optical plate achieves local dimming through the dimming liquid crystal panel, and therefore replacing the direct-type backlight module that needs to use a plurality of LEDs to achieve local dimming. Thus, the number of LEDs being used can greatly reduce and the manufacturing cost of the backlight module is reduced.

2. The use of a light source module as a backlight module instead of a direct-type backlight module improves the lack of the light mixing distance cannot be shortened due to the number of LEDs used (cost consideration) and the thickness of the backlight module cannot be reduced.

3. The display device of the embodiment can enhance the contrast of the display screen by means of local dimming of the light source module.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A light source module, comprising an optical plate, a light source and a dimming liquid crystal panel, wherein
the optical plate has a light incident surface and a light exit surface;
the light source is disposed beside the light incident surface; and
the dimming liquid crystal panel and the light exit surface of the optical plate are disposed opposite to each other, the dimming liquid crystal panel comprises a first driving substrate, a second driving substrate and a liquid crystal material layer, and the liquid crystal material layer is disposed between the first driving substrate and the second driving substrate, wherein,
the first driving substrate comprises a first substrate and a common electrode, and the common electrode is disposed between the first substrate and the liquid crystal material layer,
the second driving substrate comprises a second substrate, a plurality of independent electrodes, a plurality of first signal pads and a plurality of first wires, wherein the independent electrodes, the first signal pads and the first wires are disposed between the second substrate and the liquid crystal material layer, the independent electrodes are insulated each other, the first signal pads are disposed on at least one side of the second substrate, and each of the independent electrodes is electrically connected to one of the first signal pads via one of the first wires.

2. The light source module according to claim 1, wherein the dimming liquid crystal panel further comprises a first polarizer and a second polarizer,
the first substrate is located between the first polarizer and the liquid crystal material layer, and the first polarizer comprises at least one of a first absorption-type polarizing layer and a first reflection-type polarizing layer; and
the second substrate is located between the second polarizer and the liquid crystal material layer, and the second polarizer comprises at least one of a second absorption-type polarizing layer and a second reflection-type polarizing layer.

3. The light source module according to claim 1, wherein a liquid crystal alignment mode of the liquid crystal material layer comprises twisted nematic, super twisted nematic, vertical alignment or in-plane switching.

4. The light source module according to claim 1, wherein material of the independent electrodes, the first wires and the first signal pads are transparent conductive materials.

5. The light source module according to claim 1, wherein a material of the independent electrodes is a transparent conductive material, and materials of the first signal pads and the first wires are metal materials.

6. The light source module according to claim 1, wherein the first signal pads are disposed on opposite sides of the second substrate.

7. The light source module according to claim 1, wherein the independent electrodes are arranged in a matrix.

8. The light source module according to claim 1, wherein the dimming liquid crystal panel further comprises a light shielding pattern layer disposed on the common electrode of the first driving substrate and facing the second driving substrate, and the light shielding pattern layer corresponds to between the two adjacent independent electrodes.

9. The light source module according to claim 1, further comprising a light shielding pattern layer disposed between the two adjacent independent electrodes of the second driving substrate.

10. The light source module according to claim 1, further comprising a diffusion plate disposed at a side of the dimming liquid crystal panel away from the optical plate.

11. The light source module according to claim 10, wherein a surface of the diffusion plate has an embossed pattern, and a material of the diffusion plate comprises polycarbonate (PC), cyclic olefin polymer (COP), cyclic olefin copolymer (COC) or polymethyl methacrylate (PMMA).

12. The light source module according to claim 1, wherein an edge of each of the independent electrodes is an indented structure.

13. The light source module according to claim 12, wherein the indented structure comprises a plurality of connected indented portions, a height between a tooth peak and a tooth valley of each of the indented portions is less than 100 microns, and a distance between the two adjacent tooth peaks is less than 100 microns.

14. The light source module according to claim 1, wherein the common electrode comprises a plurality of independent sub-electrodes, the first driving substrate further comprises a plurality of second signal pads and a plurality of second wires, the independent sub-electrodes, the second signal pads and the second wires are disposed between the first substrate and the liquid crystal material layer, the independent sub-electrodes are insulated each other and respectively correspond to the independent electrodes, the second signal pads are disposed on at least one side of the first substrate, each of the independent sub-electrodes is electrically connected to one of the second signal pads by one of the second wires.

15. A display device, comprising a light source module and a display panel, wherein
the light source module comprises an optical plate, a light source and a dimming liquid crystal panel, the optical plate has a light incident surface and a light exit surface, the light source is disposed beside the light incident surface, the dimming liquid crystal panel and the light exit surface of the optical plate are disposed opposite to each other, the dimming liquid crystal panel comprises a first driving substrate, a second driving substrate and a liquid crystal material layer, and the liquid crystal material layer is disposed between the first driving substrate and the second driving substrate, wherein
the first driving substrate comprises a first substrate and a common electrode, the common electrode is disposed between the first substrate and the liquid crystal material layer;
the second driving substrate comprises a second substrate, a plurality of independent electrodes, a plurality of first signal pads and a plurality of first wires, wherein the independent electrodes, the first signal pads and the first wires are disposed between the second substrate and the liquid crystal material layer, the independent electrodes are insulated each other, the first signal pads are disposed on at least one side of the second substrate, and each of the independent electrodes is electrically connected to one of the first signal pads by one of the first wires; and
the display panel is disposed on a side of the dimming liquid crystal panel away from the optical plate.

16. The display device according to claim 15, wherein the dimming liquid crystal panel further comprises a first polarizer and a second polarizer,
the first substrate is located between the first polarizer and the liquid crystal material layer, and the first polarizer comprises at least one of a first absorption-type polarizing layer and a first reflection-type polarizing layer; and
the second substrate is located between the second polarizer and the liquid crystal material layer, and the second polarizer comprises at least one of a second absorption-type polarizing layer and a second reflection-type polarizing layer.

17. The display device according to claim 16, wherein the display panel comprises a panel module and a third polarizer, and the third polarizer is disposed on a side of the panel module away from the dimming liquid crystal panel.

18. The display device according to claim 17, wherein the display panel further comprises a fourth polarizer disposed on a side of the panel module facing the dimming liquid crystal panel.

19. The display device according to claim 15, further comprising a diffusion plate disposed between the dimming liquid crystal panel and the display panel.

20. The display device according to claim 18, wherein the light source module further comprises a diffusion plate disposed between the fourth polarizer of the display panel and the dimming liquid crystal panel, the first driving substrate of the dimming liquid crystal panel is disposed on a side of the liquid crystal material layer away from the optical plate, the first polarizer is located between the fourth polarizer and the first driving substrate, the first polarizer comprises a first absorption-type polarizing layer and a first reflection-type polarizing layer, the fourth polarizer comprises a fourth absorption-type polarizing layer and a fourth reflection-type polarizing layer, the fourth reflection-type polarizing layer and the first reflection-type polarizing layer are located between the first absorption-type polarizing layer and the fourth absorption-type polarizing layer, and the diffusion plate is disposed between the first reflection-type polarizing layer and the fourth reflection-type polarizing layer.

21. The display device according to claim 18, wherein the light source module further comprises a diffusion plate disposed between the fourth polarizer of the display panel and the dimming liquid crystal panel, the second driving substrate of the dimming liquid crystal panel is disposed on a side of the liquid crystal material layer away from the optical plate, the second polarizer is located between the fourth polarizer and the second driving substrate, the second polarizer comprises a second absorption-type polarizing layer and a second reflection-type polarizing layer, the fourth polarizer comprises the fourth absorption-type polarizing layer and the fourth reflection-type polarizing layer, the fourth reflection-type polarizing layer and the second reflection-type polarizing layer are located between the second absorption-type polarizing layer and the fourth absorption-type polarizing layer, the diffusion plate is disposed between the second reflection-type polarizing layer and the fourth reflection-type polarizing layer.

22. The display device according to claim 15, wherein an edge of each of the independent electrodes is an indented structure.

23. The display device according to claim 15, wherein the common electrode comprises a plurality of independent sub-electrodes, the first driving substrate further comprises a plurality of second signal pads and a plurality of second wires, the independent sub-electrodes, the second signal pads and the second wires are disposed between the first substrate and the liquid crystal material layer, the independent sub-electrodes are insulated each other and respectively correspond to the independent electrodes, the second signal pads are disposed on at least one side of the first substrate, each of the independent sub-electrodes is electrically connected to one of the second signal pads by one of the second wires.
